(19) United States
(12) Patent Application Publication
(10) Pub. No.: US 2024/0427183 A1
(43) Pub. Date: Dec. 26, 2024

(54) LIQUID CRYSTAL WRITING SCREEN AND PREPARATION METHOD THEREOF

(71) Applicants: Hefei Xinsheng Optoelectronics Technology Co., Ltd., Hefei, Anhui (CN); BOE TECHNOLOGY GROUP CO., LTD., Beijing (CN)

(72) Inventors: Ran ZHANG, Beijing (CN); Yongxian XIE, Beijing (CN); Chengshao YANG, Beijing (CN); Xiaoye MA, Beijing (CN); Yongcan WANG, Beijing (CN); Fengzhen LV, Beijing (CN); Zhiwei DING, Beijing (CN)

(21) Appl. No.: 18/290,762

(22) PCT Filed: Jul. 29, 2022
(86) PCT No.: PCT/CN2022/108859

§ 371 Date: Jan. 20, 2024

(51) Int. Cl. G02F 1/1333; G02F 1/1339; G02F 1/1343; G02F 1/1345; G02F 1/1368

(52) U.S. Cl. CPC G02F 1/13338; G02F 1/1339; G02F 1/134309; G02F 1/13452; G02F 1/13458; G02F 1/1368

(57) ABSTRACT

A liquid crystal writing screen, including: first substrate and second substrates, and a bistable liquid crystal layer between the first and second substrates, where the first substrate includes: a first base substrate; a plurality of pixel units on a side of the first base substrate proximate to the second substrate, each pixel unit including a thin film transistor, and a pixel electrode electrically connected to a first electrode of the thin film transistor; a passivation layer on a side of the thin film transistor distal from the first base substrate and in contact with the thin film transistor; where the pixel electrode is between the first base substrate and the passivation layer; and a spacer on a side of the passivation layer distal from the first base substrate and in contact with the passivation layer. A method for preparing the liquid crystal writing screen is further provided.

### TECHNICAL FIELD

The present disclosure relates to the field of display, and particularly relates to a liquid crystal writing screen and a preparation method thereof.

### BACKGROUND

As a simple input device, the liquid crystal writing screen can meet requirements of writing and drawing, and thus is favored by users. Current liquid crystal writing screens mostly achieve a visual effect by reflecting ambient light by means of bistable liquid crystals, and have low power consumption. However, the liquid crystal writing screens in the existing art often have complex structures and involve a complicated preparation process.

### SUMMARY

In a first aspect, an embodiment of the present disclosure provides a liquid crystal writing screen, including a first substrate, a second substrate, and a bistable liquid crystal layer between the first substrate and the second substrate, wherein the first substrate includes:
a first base substrate;
a plurality of pixel units on a side of the first base substrate proximate to the second substrate, each pixel unit including a thin film transistor, and a pixel electrode electrically connected to a first electrode of the thin film transistor;
a passivation layer on a side of the thin film transistor distal from the first base substrate and in contact with the thin film transistor; wherein the pixel electrode is between the first base substrate and the passivation layer; and
a spacer on a side of the passivation layer distal from the first base substrate and in contact with the passivation layer.

In some embodiments, the thin film transistor includes a gate, an active layer, the first electrode, and a second electrode, wherein the first electrode and the second electrode are on a side of the active layer distal from the first base substrate; and the passivation layer is in contact with the first electrode and/or the second electrode.

In some embodiments, the gate is on a side of the active layer proximate to the first base substrate, and a gate insulating layer is between the gate and the active layer; and the pixel electrode is between the gate insulating layer and the passivation layer, or between the gate insulating layer and the first base substrate.

In some embodiments, the pixel electrode is on a side of the gate proximate to the first base substrate.

In some embodiments, the array substrate includes a first conductive layer, and a second conductive layer on a side of the first conductive layer distal from the first base substrate;
the first conductive layer includes the pixel electrode and a first conductive structure in the same layer as the pixel electrode;
the second conductive layer includes the gate and a second conductive structure in the same layer as the gate; and
an orthographic projection of the first conductive layer on the first base substrate covers an orthographic projection of the second conductive layer on the first base substrate.

In some embodiments, the pixel electrode is in the same layer as the gate.

In some embodiments, the pixel electrode is electrically connected to the corresponding first electrode through a first conductive connection structure;
the passivation layer includes a via into which at least part of the first conductive connection structure is received; and
an orthographic projection of the first conductive connection structure on the base substrate has an area less than an area of an orthographic projection of the pixel electrode connected to the first conductive connection structure on the base substrate.

In some embodiments, the passivation layer is formed with a first via communicated from a side surface of the passivation layer distal from the first base substrate to the first electrode and the pixel electrode corresponding to the first electrode; and
at least part of the first conductive connection structure is in the first via, and the first conductive connection structure is in contact with both of the first electrode and the pixel electrode corresponding to the first electrode.

In some embodiments, the orthographic projection of the first conductive connection structure on the first base substrate is overlapped with an orthographic projection of the first via on the first base substrate.

In some embodiments, the passivation layer is formed with a second via set including at least two second vias, wherein at least one second via in the second via set is communicated from a side surface of the passivation layer distal from the first base substrate to the first electrode, and at least one second via in the second via set is communicated from the side surface of the passivation layer distal from the first base substrate to the pixel electrode corresponding to the first electrode;
the first conductive connection structure is in one-to-one correspondence with the second via set, and includes at least two first conductive connection sub-structures and a second conductive connection sub-structure;
the first conductive connection sub-structures are in one-to-one correspondence with the second vias in the corresponding second via set, and each of the first conductive connection sub-structures is in a corresponding one of the second vias, and in contact with the first electrode or the pixel electrode; and
the second conductive connection sub-structure is on a side of the passivation layer distal from the first base substrate, and connected to the first conductive connection sub-structures to electrically connect the first electrode to the pixel electrode.

In some embodiments, for any second via in the second via set, the second via has a first orthographic projection on the first base substrate, and the first conductive connection structure corresponding to the second via has a second orthographic projection on the first base substrate; and
the first orthographic projection is in a coverage area of the second orthographic projection, and a distance from any point on an edge of the first orthographic projection to any point on an edge of the second orthographic projection is greater than or equal to 1 μm.

In some embodiments, for any second via in the second via set that is communicated from the side surface of the passivation layer distal from the first base substrate to the first electrode, the second via has a third orthographic projection on the first base substrate, and the first electrode corresponding to the second via has a fourth orthographic projection on the first base substrate; and the third orthographic projection is in a coverage area of the fourth orthographic projection, and a distance from any point on an edge of the third orthographic projection to any point on an edge of the fourth orthographic projection is greater than or equal to 1 μm.

In some embodiments, for any second via in the second via set that is communicated from the side surface of the passivation layer distal from the first base substrate to the pixel electrode, the second via has a fifth orthographic projection on the first base substrate, and the pixel electrode corresponding to the second via has a sixth orthographic projection on the first base substrate; and the fifth orthographic projection is in a coverage area of the sixth orthographic projection, and a distance from any point on an edge of the fifth orthographic projection to any point on an edge of the sixth orthographic projection is greater than or equal to 1 μm.

In some embodiments, the first conductive connection structure is made of a material including a transparent conductive material including a metal oxide;
a total contact surface area between the first conductive connection structure and the first electrode connected to the first conductive connection structure is in a range of 100 μm² to 400 μm²; and
a total contact surface area between the first conductive connection structure and the pixel electrode connected to the first conductive connection structure is in a range of 100 μm² to 400 μm².

In some embodiments, the first conductive connection structure is made of a material including a metal material;
a total contact surface area between the first conductive connection structure and the first electrode connected to the first conductive connection structure is in a range of 0.25μm² to 2.25μ; and
a total contact surface area between the first conductive connection structure and the pixel electrode connected to the first conductive connection structure is in a range of 0.25 μm² to 2.25 μm².

In some embodiments, the liquid crystal writing screen further includes:
a plurality of pads in a peripheral region of the liquid crystal writing screen and in the same layer as the gate of the thin film transistor;
the passivation layer is formed with a third via communicated to the pad, and a second conductive connection structure is formed on a side wall of the third via and on a surface of the pad distal from the first base substrate; and
the second conductive connection structure is in the same layer as the first conductive connection structure.

In some embodiments, a portion of the pixel electrode is lapped on a side surface of the corresponding first electrode distal from the first base substrate.

In some embodiments, an orthographic projection of the active layer on the first base substrate covers orthographic projections of the first electrode and the second electrode on the first base substrate.

In some embodiments, the spacer has a density of 100/mm² to 500/mm².

In some embodiments, the second base substrate is a flexible substrate.

In a second aspect, an embodiment of the present disclosure further provides a method for preparing the liquid crystal writing screen according to the first aspect, including:
preparing a first substrate and a second substrate;
aligning and assembling the first substrate and the second substrate, and forming a bistable liquid crystal layer between the first substrate and the second substrate;
wherein preparing the second substrate includes:
providing a first base substrate;
forming a plurality of pixel units on a side of the first base substrate, each pixel unit including: a thin film transistor, and a pixel electrode electrically connected to a first electrode of the thin film transistor;
forming a passivation layer on a side of the thin film transistor and the pixel electrode distal from the first base substrate, wherein the passivation layer is in contact with the thin film transistor; and
forming a spacer on a side of the passivation layer distal from the first base substrate, wherein the spacer is in contact with the passivation layer.

In some embodiments, forming the plurality of pixel units on the side of the first base substrate includes: forming the pixel electrode and forming a gate; and forming the pixel electrode and forming the gate includes:
forming a first conductive material film;
forming a second conductive material film on a side of the first conductive material film distal from the first base substrate; and
patterning the first conductive material film and the second conductive material film through a half tone mask patterning process, to obtain a pattern of a first conductive layer and a pattern of a second conductive layer, wherein the first conductive layer includes the pixel electrode and a first conductive structure in the same layer as the pixel electrode, the second conductive layer includes the gate and a second conductive structure in the same layer as the gate, and an orthographic projection of the first conductive layer on the first base substrate covers an orthographic projection of the second conductive layer on the first base substrate.

In some embodiments, forming the plurality of pixel units on the side of the first base substrate further includes: forming an active layer, and forming the first electrode and a second electrode;

forming the active layer and forming the first electrode and the second electrode includes:

forming an active material film;

forming a third conductive material film on a side of the active material film distal from the first base substrate; and

patterning the active material film and the third conductive material film through a half tone mask patterning process to obtain a pattern of the active layer and a pattern of a third conductive layer, wherein the third conductive layer includes the first electrode, the second electrode, and a third conductive structure in the same layer as the first electrode and the second electrode, and an orthographic projection of the active layer on the first base substrate covers orthographic projections of the first electrode and the second electrode on the first base substrate.

In some embodiments, the pixel electrode is electrically connected to the corresponding first electrode through a first conductive connection structure, and the passivation layer includes a via; and
after forming the passivation layer and before forming the spacer, the method further includes:
forming a first conductive connection structure, wherein the pixel electrode is electrically connected to the corresponding first electrode through the corresponding first conductive connection structure, and at least part of the first conductive connection structure is in the via of the passivation layer.

### BRIEF DESCRIPTION OF DRAWINGS

FIG. 1 is a schematic sectional view showing a partial region of a liquid crystal writing screen in the existing art;

FIG. 2 is a schematic sectional view showing a partial region of a first substrate in a liquid crystal writing screen in the existing art;

FIG. 3 is a schematic sectional view showing a partial region of a liquid crystal writing screen according to an embodiment of the present disclosure;

FIG. 4 is a schematic top view showing a partial region of a first substrate in a display region according to an embodiment of the present disclosure;

FIG. 5 is a schematic sectional view taken along line A-A′ in FIG. 4;

FIG. 6 is a schematic circuitry diagram of a pixel unit according to an embodiment of the present disclosure;

FIG. 7 is another schematic top view showing a partial region of a first substrate in a display region according to an embodiment of the present disclosure;

FIG. 8A is a schematic sectional view taken along line B-B′ in FIG. 7;

FIG. 8B is an enlarged partial view of a region Q in FIG. 7;

FIGS. 9A and 9B are schematic sectional views showing a partial region of a first substrate in a display region according to an embodiment of the present disclosure;

FIGS. 10A and 10B are another two schematic sectional views showing a partial region of a first substrate in a display region according to an embodiment of the present disclosure;

FIGS. 11 and 12 are yet another two schematic sectional views showing a partial region of a first substrate in a display region according to an embodiment of the present disclosure;

FIG. 13A is a schematic sectional view showing partial regions of a first substrate in a display region and a peripheral region according to an embodiment of the present disclosure;

FIG. 13B is a schematic sectional view showing partial regions of a first substrate in a display region and a peripheral region according to an embodiment of the present disclosure;

FIG. 14 is another schematic sectional view showing a partial region of a first substrate in a display region according to an embodiment of the present disclosure;

FIGS. 15A and 15B are further schematic sectional views showing a partial region of a first substrate in a display region according to an embodiment of the present disclosure;

FIG. 16 is a schematic sectional view showing a partial region of a liquid crystal writing screen according to an embodiment of the present disclosure;

FIG. 17A is a flowchart of a method for preparing a liquid crystal writing screen according to an embodiment of the present disclosure;

FIG. 17B is a flowchart of a method for preparing a first substrate according to an embodiment of the present disclosure;

FIG. 18 is a flowchart of an optional implementation of step S2 according to an embodiment of the present disclosure;

FIG. 19 is a flowchart of an optional implementation of step S201 according to an embodiment of the present disclosure;

FIG. 20 is a schematic process flow for preparing a gate and a pixel electrode through a half tone mask patterning process according to an embodiment of the present disclosure;

FIG. 21 is a flowchart of an optional implementation of step S203 according to an embodiment of the present disclosure;

FIG. 22 is a schematic process flow for preparing an active layer, a first electrode, and a second electrode through a half tone mask patterning process according to an embodiment of the present disclosure; and

FIG. 23 is a flowchart of a method for preparing a first substrate according to an embodiment of the present disclosure.

### DETAIL DESCRIPTION OF EMBODIMENTS

The present disclosure will be described in detail below with reference to the accompanying drawings. Throughout the drawings, elements the same as or similar to each other are indicated by similar reference signs. For the sake of clarity, various parts in the figures are not all drawn to scale. Moreover, some well-known parts may not be shown in the figures.

For better understanding of the present disclosure, many specific details, such as structures, materials, dimensions, and processing techniques of components, of the present disclosure are described below. However, the present disclosure may be implemented without these specific details, as will be understood by those skilled in the art.

As used herein, the expression “in a range of A to B” or “a range from A to B” defines a range including both end values A and B.

In addition, the transistors involved in the embodiments of the present disclosure may be independently selected from one of a polysilicon thin film transistor, an amorphous silicon thin film transistor, an oxide thin film transistor, or an organic thin film transistor. Specifically, reference to “first electrode” in the present disclosure means a source of a transistor, and accordingly, reference to “second electrode” means a drain of the transistor. Apparently, it should be known by those skilled in the art that the “first electrode” and the “second electrode” are exchangeable.

Furthermore, the “cross section” of a structure in an embodiment of the present disclosure refers to a section of the structure parallel to a plane where a first base substrate is located.

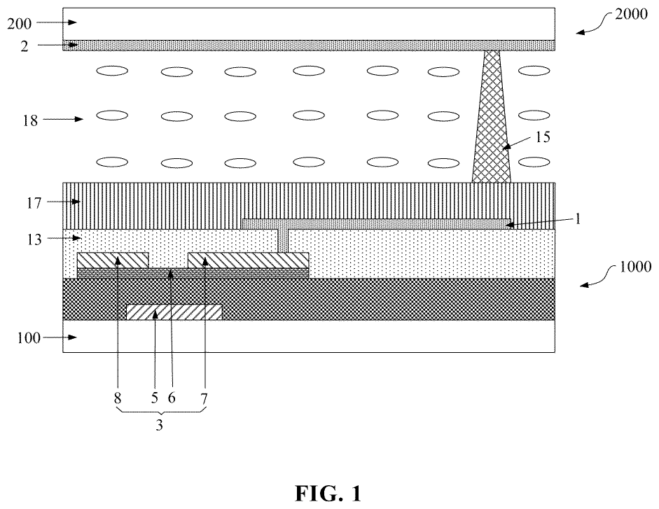

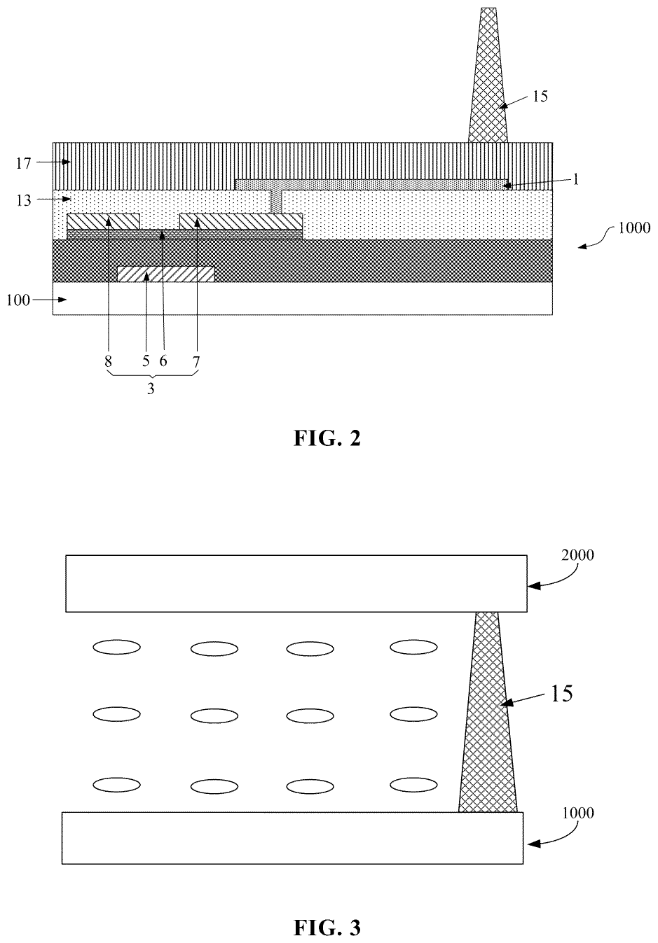

FIG. 1 is a schematic sectional view showing a partial region of a liquid crystal writing screen in the existing art, and FIG. 2 is a schematic sectional view showing a partial region of a first substrate in a liquid crystal writing screen in the existing art. As shown in FIGS. 1 and 2, the liquid crystal writing screen in the existing art includes a first substrate 1000 and a second substrate 2000 disposed opposite to each other, and a liquid crystal layer 18 between the first substrate 1000 and the second substrate 2000.

The first substrate includes a first base substrate 100, and a plurality of pixel units on a side of the first base substrate 100 facing the second substrate 2000. Each pixel unit includes a thin film transistor 3, and a pixel electrode 1 connected to a first electrode 7 of the thin film transistor 3. Generally, due to a relatively small distance between the first electrode 7 and the second electrode 8 of the thin film transistor 3 (i.e., channel length of the thin film transistor), in order to avoid short circuit between the first electrode 7 and the second electrode 8 caused by a conductive foreign matter simultaneously contacting the first electrode 7 and the second electrode 8 in use, a passivation layer 13 in contact with the thin film transistor 3 is generally prepared above the thin film transistor 3, where the passivation layer 13 can fill a gap between the first electrode 7 and the second electrode 8 and cover the first electrode 7 and the second electrode 8, so that the short circuit between the first electrode 7 and the second electrode 8 can be effectively avoided by the passivation layer 13 in use. The pixel electrode 1 is located on a side of the passivation layer 13 distal from the first base substrate 100, and the pixel electrode 1 is connected to the first electrode 7 of the corresponding thin film transistor 3 through a via in the passivation layer 13.

The second substrate 2000 includes a second base substrate 200 and a common electrode 2 on a side of the second base substrate 200 facing the first substrate 1000.

The liquid crystal layer 18 is a bistable liquid crystal layer. Specifically, the bistable liquid crystal layer includes a bistable liquid crystal material. For example, the bistable liquid crystal material may be a cholesteric liquid crystal (CLC) having two stable states.

The bistable cholesteric liquid crystal has a planar texture state (P state), a focal conic texture state (FC state), and a homeotropic texture state (H state). The P state and the FC state are stable states and do not need voltage holding, while the H state is unstable and only presents in a continuous power-on state. By applying a voltage to the pixel electrode 1 of the pixel unit or applying a pressing force to a region where the pixel unit is located, in various ways, a state of liquid crystals in the region where the pixel unit is located can be controlled.

The liquid crystal writing screen has a writing function, which is implemented based on the following principle.

When the liquid crystal writing screen is in an initial state, the liquid crystals are in the FC state, in which spiral axes of the liquid crystals in the FC state are distributed in disorder, a liquid crystal orientation is substantially parallel to a plane where the first base substrate 100 is located, cholesteric liquid crystals in the FC state present a multi-domain state, and each domain still has a spiral structure and can scatter incident light; that is, the liquid crystals in the pixel unit can scatter the incident light under the condition of a zero electric field. A background structure 4 (e.g., a black PET film) is disposed on a back of the liquid crystal writing screen. In this case, incident light will be scattered in the pixel unit and irradiates a surface of the background structure 4, so that part of the light can be reflected on the surface of the background structure 4, and then pass through the pixel unit again to be scattered. In other words, the pixel unit presents a background color (e.g., black) in an initial state. Apparently, in some cases, the background structure 4 may be omitted, in which case light (e.g., ambient light) transmitted from a bottom of the liquid crystal writing screen is used as the background color.

When the pixel unit is pressed by a touch object, the liquid crystals in the pixel unit is in the “P state”, in which the liquid crystals have a periodic spiral structure, and the spiral axes of the liquid crystals are substantially perpendicular to the plane where the first base substrate 100 is located. At this time, the liquid crystals in the P state may selectively reflect light with a wavelength λ=p1*n1, where p1 is a pitch, and n1 is an equivalent refractive index of the liquid crystal. In other words, the liquid crystals in the P state can reflect light of a particular color (depending on the material of the liquid crystals, which may be green, for example). At this time, the pixel unit presents the particular color, i.e., presents “handwriting”.

To erase the “handwriting”, a thin film transistor in a pixel unit in an erasing region is controlled to be turned on, and an initialization voltage is delivered to the thin film transistor to charge a pixel electrode in the erasing region. An initialization electric field is formed between the pixel electrode 1 and the common electrode 2, the liquid crystals present the FC state again under an action of the initialization electric field, so that the pixel unit presents the background color, and the handwriting written in the erasing region can be erased.

It should be noted that, generally, to facilitate local erasing, each pixel unit is independently controlled by a thin film transistor, so that the erasing unit is smaller. When the liquid crystal writing screen is erased, a thin film transistor in the erasing region is turned on, while a thin film transistor in a non-erasing region is turned off, in which case handwriting in the non-erasing region remains unchanged, thereby implementing local erasing of the liquid crystal writing screen.

It has been found in practical applications that there may be a conductive foreign matter in the liquid crystal layer 18, and when the liquid crystal writing screen is pressed, the conductive foreign matter is very likely to contact both the pixel electrode 1 and the common electrode 2 due to the relatively large sizes of the pixel electrode 1 and the common electrode 2, thereby causing short circuit between the pixel electrode 1 and the common electrode 2 and further a pixel unit failure at a corresponding position. To avoid the above problem, in the existing art, an insulation protective layer 17 (generally made of an inorganic insulating material, such as silicon oxide or silicon nitride) is formed on a side of the pixel electrode 1 distal from the base substrate to cover the pixel electrode 1, so that the conductive foreign matter can be prevented from contacting the pixel electrode 1, and thus the short circuit between the pixel electrode 1 and the common electrode 2 can be avoided. However, the provision of the insulation protective layer 17 may lead to a more complicated overall structure of the first substrate on one hand, and increase the preparation process of the first substrate on the other hand.

To address at least one of the technical problems in the existing art, an embodiment of the present disclosure provides a novel liquid crystal writing screen and a preparation method thereof.

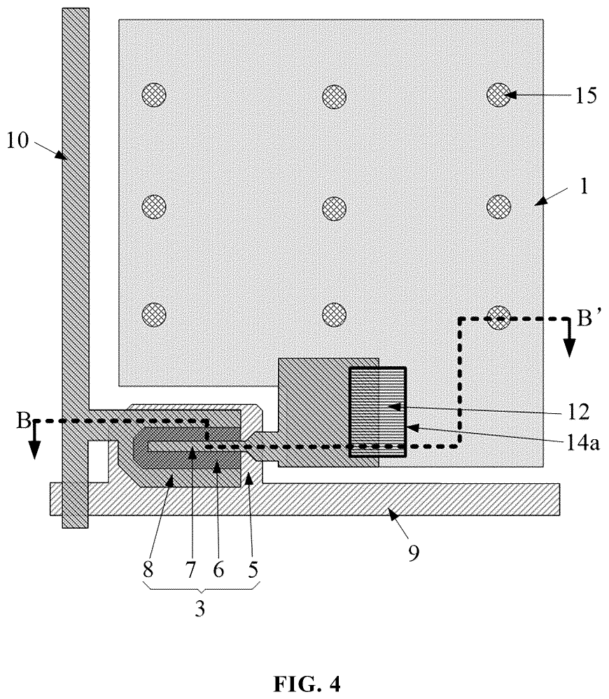

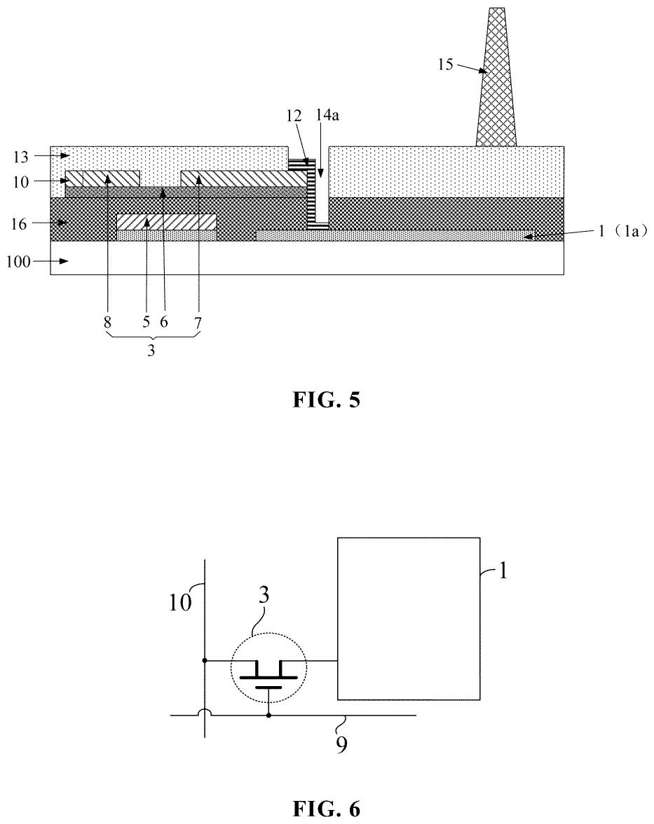

FIG. 3 is a schematic sectional view showing a partial region of a liquid crystal writing screen according to an embodiment of the present disclosure, FIG. 4 is a schematic top view showing a partial region of a first substrate in a display region according to an embodiment of the present disclosure, FIG. 5 is a schematic sectional view taken along line A-A′ in FIG. 4, and FIG. 6 is a schematic circuitry diagram of a pixel unit according to an embodiment of the present disclosure. As shown in FIGS. 3 to 6, the liquid crystal writing screen includes a first substrate 1000 and a second substrate 2000 disposed opposite to each other, and a bistable liquid crystal layer 18 between the first substrate 1000 and the second substrate 2000.

The first substrate includes a first base substrate 100, a plurality of pixel units, a passivation layer 13, and a spacer 15.

The first base substrate 100 may be a hard substrate, such as a glass substrate; or the first base substrate 100 may be a flexible substrate, such as a resin substrate. The first base substrate 100 includes a display region and a peripheral region.

A plurality of gate lines 9 and a plurality of data lines 10 are formed in the display region, and define a plurality of pixel units on a side of the first base substrate 100. Each pixel unit includes a thin film transistor 3, and a pixel electrode 1 electrically connected to a first electrode 7 of the thin film transistor 3. Generally, each gate line 9 is disposed in the same layer as a gate 5 of the thin film transistor 3, and each data line 10 is disposed in the same layer as the first electrode 7 and a second electrode 8 of the thin film transistor 3.

In some embodiments, each gate line 9 has a line width of 3 μm to 10 μm; and each data line 10 has a line width of 3 μm to 10 μm.

It should be noted that in the embodiments of the present disclosure, the arrangement of two structures in the same layer means that the two structures may be simultaneously prepared through the same patterning process based on the same material film, and distances from the two structures in the same layer to the base substrate may be the same or different.

In addition, the “patterning process” in the embodiments of the present disclosure is intended to include processes such as photoresist coating, exposure, development, thin film etching, photoresist stripping, and the like. When the material film to be patterned is a material film having a photoresist property, the material film can be patterned through the steps of only exposure and development.

The passivation layer 13 is located on a side of the thin film transistor 3 distal from the first base substrate 100 and in contact with the thin film transistor 3. The pixel electrode 1 is located between the first base substrate 100 and the passivation layer 13.

In some embodiments, the pixel electrode 1 may be made of a transparent conductive material; and optionally, the transparent conductive material includes a metal oxide, such as indium tin oxide.

In some embodiments, the spacer 15 is located on a side of the passivation layer 13 distal from the first base substrate 100, and in contact with the passivation layer 13. It will be appreciated that the spacer 15 may be directly prepared on the passivation layer 13, and provide support for the second substrate 2000.

In some embodiments, an isolation layer may be further provided between the passivation layer 13 and the bistable liquid crystal layer 18, and the isolation layer may be made of, for example, polyimide (PI). The isolation layer may be located between the passivation layer 13 and the spacer 15. Alternatively, the isolation layer may be prepared after the spacer 15 is prepared on the passivation layer 13. For example, the isolation layer may cover or partially cover the spacer 15. In some embodiments, the isolation layer may be located on the second substrate 2000, for example, between the second base substrate 200 and the bistable liquid crystal layer 18. The isolation layer can provide further insulation to better prevent short circuit caused by a foreign matter and improve the product reliability.

In some embodiments, the spacer 15 may be prepared on the second substrate 2000, and in contact with the first substrate 1000 to provide support; and the spacer 15 may be in contact with the passivation layer 13. When the isolation layer is located between the passivation layer 13 and the bistable liquid crystal layer 18, the spacer 15 may be in contact with the isolation layer.

A section of the spacer 15 parallel to the plane where the first base substrate 100 is located has a circular shape, a square shape, or a polygonal shape (e.g., a regular octagonal shape). In some embodiments, a cross section of the spacer 15 at an end in contact with the passivation layer 13 has an area in a range of 100 μm² to 225 μm².

In an embodiment of the present disclosure, since the pixel unit has a relatively large size, a part of the spacer 15 is placed in the region where the pixel electrode 1 is located to ensure the support reliability. In this case, the spacer 15 may be made of a transparent resin material to prevent the spacer 15 from shielding light in the liquid crystal layer.

Under the condition that the size of the spacer is fixed, a spacer density can influence a thickness of the handwriting. A higher spacer density will make it more difficult to press down a writing element and result in thinner handwriting; while accordingly, a lower spacer density will make it easier to press down the writing element and result in thicker handwriting. Considering the thickness of handwriting, in some embodiments, the spacer has a density of 100/mm² to 500/mm², leading to a thickness of handwriting in a range of 1 mm to 5 mm. It has been verified that the thickness of handwriting is about 3 mm when the spacer density is 324/mm².

Different from the existing art where the pixel electrode 1 is prepared on a side of the passivation layer 13 distal from the first base substrate 100, the pixel electrode 1 in the embodiments of the present disclosure is disposed between the first base substrate 100 and the passivation layer 13, so that at least the passivation layer 13 is present on a side of the pixel electrode 1 distal from the first base substrate 100, which can effectively cover the pixel electrode 1 to function as an insulation protective layer in the existing art. Through the above design, the first substrate provided in the embodiments of the present disclosure does not need an additional and separate insulation protective layer, so that compared with the first substrate in the existing art, the first substrate in the embodiments of the present disclosure has a simpler structure, and thereby, the liquid crystal writing screen provided in the embodiments of the present disclosure has a simpler structure; and since the insulation protective layer is omitted in structure, a process step for preparing the insulation protective layer is omitted during preparation of the first substrate, thereby simplifying the preparation process of the first substrate and thus the overall preparation process of the liquid crystal writing screen.

In some embodiments, one and only one passivation layer 13 is provided on the first substrate 1000, which is beneficial to simplifying the process.

In some embodiments, the thin film transistor 3 includes a gate 5, an active layer 6, a first electrode 7, and a second electrode 8. The first electrode 7 and the second electrode 8 are located on a side of the active layer 6 distal from the first base substrate 100. The passivation layer 13 is in contact with the first electrode 7 and/or the second electrode 8.

In some embodiments, the active layer 6 has a channel width-to-length ratio in a range of 40:5 to 80:5. In some embodiments, a channel length is about 5 μm, and a channel width is in a range of 40 μm to 80 μm.

It should be noted that the thin film transistor 3 in the embodiments of the present disclosure may be a bottom gate thin film transistor shown in the drawings, or may be, for example, a top gate thin film transistor or any other type of thin film transistor. Further, in addition to the thin film transistor described above, the pixel unit may further include other structures, such as transistors other than the thin film transistor shown in FIG. 6, or a capacitor structure. The specific structure of the pixel unit and the specific structure of the thin film transistor are not limited in the technical solution of the present disclosure.

In some embodiments, the pixel electrode 1 is not in direct contact with the corresponding first electrode 7, but is electrically connected to the corresponding first electrode 7 through a corresponding first conductive connection structure 12, and the passivation layer 13 includes a via into which at least part of the first conductive connection structure 12 is received. In some embodiments, an orthographic projection of the first conductive connection structure 12 on the first base substrate 100 has an area less than an area of an orthographic projection of the pixel electrode 1 connected to the first conductive connection structure 12 on the first base substrate 100.

Optionally, an ratio of an area of an orthographic projection of one first conductive connection structure 12 on the first base substrate 100 to an area of an orthographic projection of one connected pixel electrode 1 on the first base substrate 100 is less than 1:100. Preferably, an ratio of an area of an orthographic projection of one first conductive connection structure 12 on the first base substrate 100 to an area of an orthographic projection of one connected pixel electrode 1 on the first base substrate 100 is less than 0.3:100. As one example, the orthographic projection of one pixel electrode 1 on the first base substrate 100 has an area of about 500 μm*500 μm to 4000 μm*4000 μm, and the orthographic projection of one first conductive connection structure 12 on the first base substrate 100 has an area of about 5 μm*5 μm to 50 μm*50 μm.

It should be noted that although the assembled first conductive connection structure 12 will directly contact the liquid crystals in the liquid crystal layer by electrically connecting the pixel electrode 1 and the corresponding first electrode 7 via the first conductive connection structure 12, due to an extremely small area (less than 1% of the area of the pixel electrode 1) of the first conductive connection structure 12, the probability that a conductive foreign matter contacts both the first conductive connection structure 12 and the common electrode is very low, that is, the probability of short circuit between the pixel electrode 1 and the common electrode is very low.

With continued reference to FIG. 5, the passivation layer 13 is formed with a first via 14a communicated from a side surface of the passivation layer 13 distal from the first base substrate 100 to the first electrode 7 and the pixel electrode 1 corresponding to the first electrode 7. At least part of the first conductive connection structure 12 is located in the first via 14a, and the first conductive connection structure 12 is in contact with both the first electrode 7 and the pixel electrode 1 corresponding to the first electrode 7.

In addition, in design of a position of the first via 14a, contact areas of the first conductive connection structure 12 with the first electrode 7 and the pixel electrode 1 should also be considered. Optionally, the first conductive connection structure 12 and the first electrode 7 have a first contact area, the first conductive connection structure 12 and the pixel electrode 1 have a second contact area, and the first contact area and the second contact area are equal or approximately equal.

The first via 14a may be a circular via, a square via, a polygonal via, or the like, which is not specifically limited in the present disclosure.

In some embodiments, an orthographic projection of the first conductive connection structure 12 on the first base substrate 100 is overlapped with an orthographic projection of the first via 14a on the first base substrate 100. In other words, the first conductive connection structure 12 is entirely located within the corresponding first via 14a, and there is no part of first conductive connection structure 12 on the side of the passivation layer 13 distal from the first base substrate 100. With such a design, the size of the first conductive connection structure 12 can be minimized, which is beneficial to reducing the contact probability of the first conductive connection structure 12 with a conductive foreign matter.

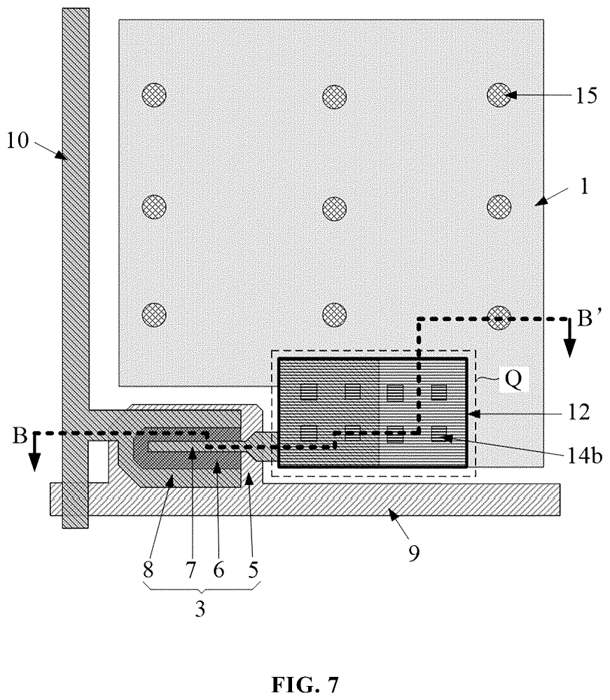

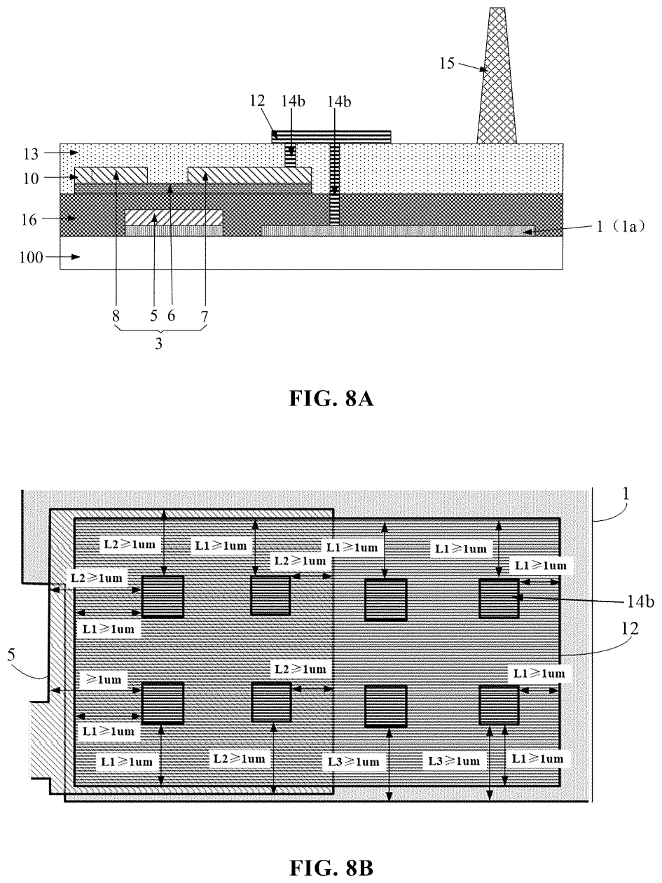

FIG. 7 is another schematic top view showing a partial region of a first substrate in a display region according to an embodiment of the present disclosure, FIG. 8A is a schematic sectional view taken along line B-B′ in FIG. 7, and FIG. 8B is an enlarged partial view of a region Q in FIG. 7. As shown in FIGS. 7 to 8B, in some embodiments, the passivation layer 13 is formed with a second via set including at least two second vias 14b. At least one second via 14b in the second via set is communicated from a side surface of the passivation layer 13 distal from the first base substrate 100 to the first electrode 7, and at least one second via 14b in the second via set is communicated from the side surface of the passivation layer 13 distal from the first base substrate 100 to the pixel electrode 1 corresponding to the first electrode 7. The first conductive connection structure 12 is provided in one-to-one correspondence with the second via set, and includes at least two first conductive connection sub-structures and a second conductive connection sub-structure. The first conductive connection sub-structures are provided in one-to-one correspondence with the second vias 14b in the corresponding second via set, located in the respective second vias 14b, and in contact with the first electrode 7 or the pixel electrode 1. The second conductive connection sub-structure is located on a side of the passivation layer 13 distal from the first base substrate 100, and connected to the first conductive connection sub-structures.

In the solution of defining the first via 14a shown in FIGS. 4 and 5, the first via 14a is desired to be defined in an edge region of the first electrode 7, to ensure that the first via 14a can be communicated to both the first electrode 7 and the pixel electrode 1. Compared with the solution of defining the first via 14a shown in FIGS. 4 and 5, the solution of defining the second via set shown in FIGS. 7 and 8 allows positions of the second vias 14b more flexible. However, since the second conductive connection sub-structure must be disposed above the passivation layer 13, a sectional area of the first conductive connection structure 12 in FIGS. 7 and 8 is greater than a sectional area of the first conductive connection structure 12 in FIGS. 4 and 5, in a case where a sectional area of all second vias 14b in one second via set is equal to a sectional area of one first via 14a in FIGS. 4 and 5, and the first conductive connection structure 12 in FIGS. 4 and 5 is entirely located within the first via 14a.

In addition, since the first via 14a is desired to be communicated to both the first electrode 7 and the pixel electrode 1, while the second via 14b is desired to be communicated to only the first electrode 7 or only the pixel electrode 1, the second via 14b has a smaller sectional area than the first via 14a. Moreover, since the second via 14b has a relatively small size, the first conductive connection structure 12 can effectively fill the second via 14b when prepared, and a liquid crystal cell gap in the region where the second via 14b is located is substantially the same as a standard cell gap in a region without the second via 14b. In other words, light emitted from the region with the second via 14b and light emitted from the region without the second via 14b have substantially the same brightness. Therefore, compared to the pixel unit in FIGS. 4 and 5, the pixel unit in FIGS. 7 and 8 has a more uniform light-emitting brightness in the region where the pixel unit is located.

In practical applications, a smaller contact area of the first conductive connection structure with the pixel electrode 1 or the first electrode 7 requires a smaller size of the first via 14a/the second via 14b, while a greater resistance of a portion within the first via 14a/the second via 14b results in a higher power consumption of a portion of the first conductive connection structure in the first via 14a/the second via 14b when an average current (generally about 37 mA) is constant during charging and erasing of a single pixel. While a larger contact area of the first conductive connection structure with the pixel electrode 1 or the first electrode 7 requires a larger size of the first via 14a/the second via 14b, which may lead to a larger size of the first conductive connection structure and an increased probability of the conductive foreign matter in contact with the first conductive connection structure 12. In addition, a liquid crystal cell gap at a region where the first via 14a/the second via 14b is located is greater than a liquid crystal cell gap at a region without the first via 14a/the second via 14b, and taking the liquid crystal cell gap at the region without the first via 14a/the second via 14b as a standard cell gap, the region where the first via 14a/the second via 14b is located has an abnormal liquid crystal cell gap and reflects a different brightness of light from the standard cell gap region. In this case, a larger size of the first via 14a/the second via 14b leads to a larger abnormal cell gap region, a worse uniformity in the liquid crystal cell gap, and a worse uniformity in the light-emitting brightness across the region where the pixel unit is located.

Based on the above considerations, in some embodiments, the first conductive connection structure 12 is made of a material including a transparent conductive material including a metal oxide (e.g., indium tin oxide); a total contact surface area between the first conductive connection structure 12 and the first electrode 7 connected to the first conductive connection structure is in a range of 100 μm² to 400 μm²; and a total contact surface area between the first conductive connection structure 12 and the pixel electrode 1 connected to the first conductive connection structure is in a range of 100 μm² to 400 μm².

As one example, when the first conductive connection structure 12 is made of a transparent conductive metal oxide material, in the solution shown in FIGS. 4 and 5, one pixel unit corresponds to one first via 14a, and the first via 14a has a sectional area of 200 μm² to 800 μm², where a portion communicated to the first electrode 7 at a bottom has a sectional area of 100 μm² to 400 μm², and a portion communicated to the pixel electrode 1 at a bottom has a sectional area of 100 μm² to 400 μm².

As one example, when the first conductive connection structure 12 is made of a transparent conductive metal oxide material, in the solution shown in FIGS. 7 and 8, one pixel unit corresponds to eight second vias 14b, where four of the second vias 14b are communicated to the pixel electrode 1, and the other four of the second vias 14b are communicated to the first electrode 7. A bottom of each first via has a sectional area of 25 μm² to 100 μm².

In other embodiments, the first conductive connection structure 12 is made of a material including a metal material (e.g., aluminum or molybdenum), where since the metal has better conductive properties than the metal oxide, relatively small contact areas may be provided between the first conductive connection structure 12 and the first electrode 7 and between the first conductive connection structure 12 and the pixel electrode. A total contact surface area between the first conductive connection structure 12 and the first electrode 7 connected to the first conductive connection structure is in a range of 0.25 μm² to 2.25 μm²; and a total contact surface area between the first conductive connection structure 12 and the pixel electrode 1 connected to the first conductive connection structure is in a range of 0.25 μm² to 2.25 μm².

Since the metal material has a lower light transmittance than the transparent conductive material, when the first conductive connection structure is made of a metal material, the first conductive connection structure may block light that is emitted to the background structure to a certain extent, and thus affect the display effect of the pixel unit when the pixel unit presents the background color.

It should be noted that FIG. 4 merely exemplarily depicts a case where one pixel unit corresponds to one first via 14a; and FIG. 7 exemplarily depicts a case where one pixel unit corresponds to second vias 14b, where four of the second vias 14b are communicated to the first electrode 7, and the other four of the second vias 14b are communicated to the pixel electrode 1. The above cases are merely for exemplary purposes, and do not constitute any limitation to the technical solution of the present disclosure.

As one aspect, in practical production lines, due to process fluctuations (actual positions of the second vias 14b may deviate from design positions thereof) in the etching process of the passivation layer 13, and misalignment between the first conductive connection structure 12 and the passivation layer 13 in the preparation process of the first conductive connection structure 12, there may be a case that the first conductive connection structure 12 cannot completely cover one or more second vias 14b, that is, a product defect.

To effectively improve the above technical problem, in some embodiments, for any second via 14b in the second via set, the second via 14b has a first orthographic projection on the first base substrate 100, and the first conductive connection structure 12 corresponding to the second via 14b has a second orthographic projection on the first base substrate 100. In the design stage, the first orthographic projection is located in a coverage area of the second orthographic projection, and a distance from any point on an edge of the first orthographic projection to any point on an edge of the second orthographic projection is greater than or equal to 2.5 μm. In the practical production and preparation process, the above design can enable the first conductive connection structure 12 to still completely cover all the second vias 14b even under the condition of process fluctuations in the etching process of the passivation layer 13 and misalignment between the first conductive connection structure 12 and the passivation layer 13. It is verified that when a distance from any point on an edge of the first orthographic projection to any point on an edge of the second orthographic projection is designed to be greater than or equal to 2.5 μm in the design stage, in the actually prepared product, a distance L1 from any point on an edge of the first orthographic projection to any point on an edge of the second orthographic projection is greater than or equal to 1 μm. In other words, there is still a certain distance between the edge of the first orthographic projection and the edge of the second orthographic projection, so as to handle greater fluctuations in the passivation layer etching process and greater misalignment, thereby increasing the yield of the production line.

As another aspect, in practical production lines, due to process fluctuations in the etching process of the passivation layer 13 and misalignment between the passivation layer 13 and the first electrode 7, one or more second vias 14b to be communicated to the first electrode 7 may no longer be located in the region where the first electrode 7 is located, causing abnormal connection between the subsequently formed first conductive connection structure 12 and the first electrode 7, that is, a product defect.

To effectively improve the above technical problem, in some embodiments, for any second via 14b communicated to the first electrode 7 in the second via set, the second via 14b has a third orthographic projection on the first base substrate 100, and the first electrode 7 corresponding to the second via 14b has a fourth orthographic projection on the first base substrate 100. In the design stage, the third orthographic projection is located in a coverage area of the fourth orthographic projection, and a distance from any point on an edge of the third orthographic projection to any point on an edge of the fourth orthographic projection is greater than or equal to 2.5 μm. In the practical production and preparation process, the above design can, under the condition of fluctuations in the etching process of the passivation layer 13 and misalignment between the passivation layer 13 and the first electrode 7, have all the second vias 14b to be communicated to the first electrode 7 located in the region where the first electrode 7 is located, and thus ensure the connection reliability between the subsequently formed first conductive connection structure 12 and the first electrode 7. It is verified that when a distance from any point on an edge of the third orthographic projection to any point on an edge of the fourth orthographic projection is designed to be greater than or equal to 2.5 μm in the design stage, in the actually prepared product, a distance L2 from any point on an edge of the third orthographic projection to any point on an edge of the fourth orthographic projection is greater than or equal to 1 μm. In other words, there is still a certain distance between the edge of the third orthographic projection and the edge of the fourth orthographic projection, so as to handle greater fluctuations in the passivation layer etching process and greater misalignment, thereby increasing the yield of the production line.

As yet another aspect, in practical production lines, due to process fluctuations in the etching process of the passivation layer 13 and misalignment between the passivation layer 13 and the pixel electrode 1, one or more second vias 14b to be communicated to the pixel electrode 1 may no longer be located in the region where the pixel electrode 1 is located, causing abnormal connection between the subsequently formed first conductive connection structure 12 and the pixel electrode 1, that is, a product defect.

To effectively improve the above technical problem, in some embodiments, for any second via 14b communicated to the pixel electrode 1 in the second via set, the second via 14b has a fifth orthographic projection on the first base substrate 100, and the pixel electrode 1 corresponding to the second via 14b has a sixth orthographic projection on the first base substrate 100. In the design stage, the fifth orthographic projection is located in a coverage area of the sixth orthographic projection, and a distance from any point on an edge of the fifth orthographic projection to any point on an edge of the sixth orthographic projection is greater than or equal to 2.5 μm. In the practical production and preparation process, the above design can, under the condition of fluctuations in the etching process of the passivation layer 13 and misalignment between the passivation layer 13 and the pixel electrode 1, have all the second vias 14b to be communicated to the pixel electrode 1 located in the region where the pixel electrode 1 is located, and thus ensure the connection reliability between the subsequently formed first conductive connection structure 12 and the pixel electrode 1. It is verified that when a distance from any point on an edge of the fifth orthographic projection to any point on an edge of the sixth orthographic projection is designed to be greater than or equal to 2.5 μm in the design stage, in the actually prepared product, a distance L3 from any point on an edge of the fifth orthographic projection to any point on an edge of the sixth orthographic projection is greater than or equal to 1 μm. In other words, there is still a certain distance between the edge of the fifth orthographic projection and the edge of the sixth orthographic projection, so as to handle greater fluctuations in the passivation layer etching process and greater misalignment, thereby increasing the yield of the production line.

In some embodiments, the first conductive connection structure 12 is made of a material including a transparent conductive material. The transparent conductive material may be a metal oxide material, such as indium tin oxide.

Referring to FIGS. 5 and 8A, in some embodiments, a gate 5 is located on a side of the active layer 6 proximate to the first base substrate 100, a gate insulating layer 16 is formed between the gate 5 and the active layer 6, and the pixel electrode 1 is located between the gate insulating layer 16 and the first base substrate 100.

In some embodiments, one and only one gate insulating layer 16 is provided on the first substrate 1000.

Further, in the solution shown in FIGS. 5 and 8A, the pixel electrode 1 is located on a side of the gate 5 proximate to the first base substrate 100.

In some embodiments, the first substrate includes a first conductive layer 1a, and a second conductive layer on a side of the first conductive layer 1a distal from the first base substrate 100. The first conductive layer 1a includes a pixel electrode 1 and a first conductive structure (e.g., a portion directly below the gate line 9, and a portion directly below the gate 5) disposed in the same layer as the pixel electrode 1. The second conductive layer includes a gate 5 and a second conductive structure (e.g., the gate line 9) disposed in the same layer as the gate 5. An orthographic projection of the first conductive layer 1a on the first base substrate 100 covers an orthographic projection of the second conductive layer on the first base substrate 100.

In an embodiment of the present disclosure, when the pixel electrode 1 is disposed on the side of the gate 5 proximate to the first base substrate 100, the pixel electrode 1 and the gate 5 may be prepared through one mask process based on a half tone mask (HTM) patterning process, which is beneficial to reducing the number of mask processes in the preparation flow of the first substrate and reducing the production cost. For the process of preparing the pixel electrode 1 and the gate 5 through the half tone mask patterning process, reference may be made to the following.

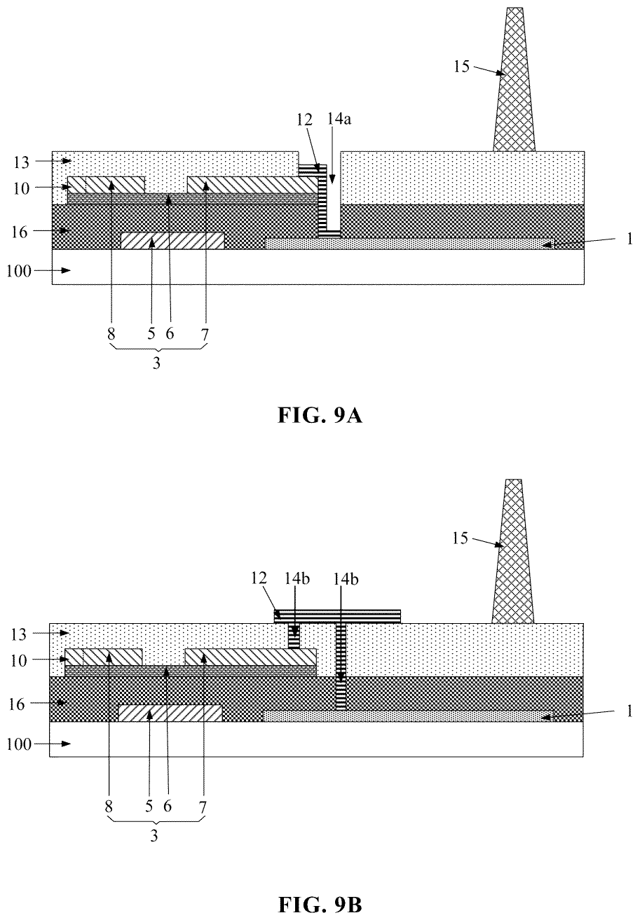

FIGS. 9A and 9B are schematic sectional views showing a partial region of a first substrate in a display region according to an embodiment of the present disclosure. As shown in FIGS. 9A and 9B, unlike the case where the pixel electrode 1 is located on the side of the gate 5 proximate to the first base substrate 100 as shown in FIGS. 5 and 8A, in the solution shown in FIGS. 9A and 9B, both the pixel electrode 1 and the gate 5 are in contact with the first base substrate 100; and the pixel electrode and the gate are made of different materials. For example, the pixel electrode is made of a transparent conductive material (e.g., a metal oxide), and the gate is made of a metal material. In this case, the pixel electrode 1 and the gate 5 are separately prepared through different patterning processes (with different masks).

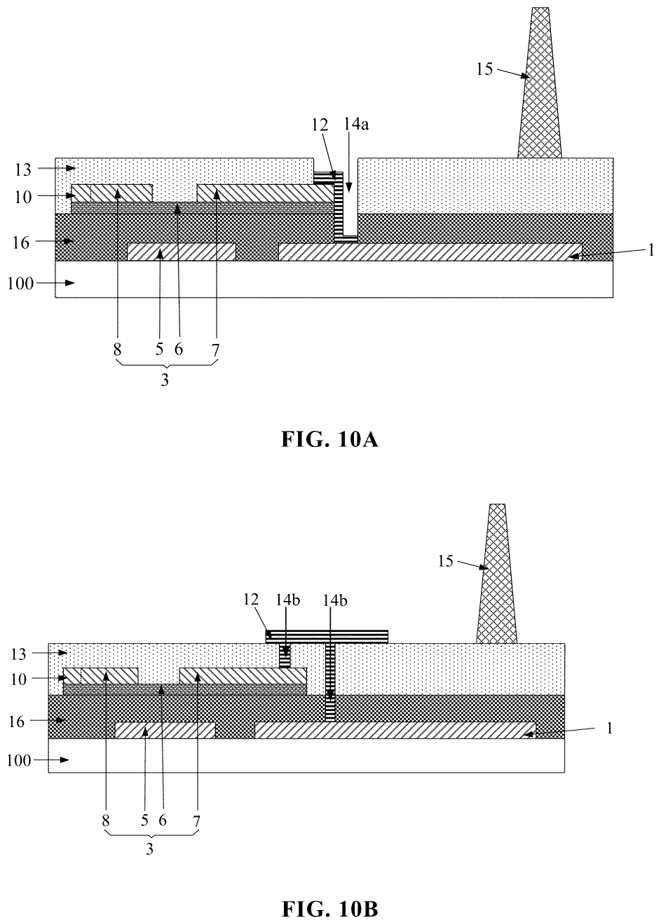

FIGS. 10A and 10B are another two schematic sectional views showing a partial region of a first substrate in a display region according to an embodiment of the present disclosure. As shown in FIGS. 10A and 10B, in some embodiments, the pixel electrode is disposed in the same layer as the gate. In other words, the pixel electrode and the gate are prepared based on the same material film (e.g., a metal material film). In this case, the pixel electrodes can be simultaneously manufactured based on the existing gate preparation process, which is beneficial to reducing the number of mask processes.

It should be noted that when the pixel electrode is made of a metal material, the pixel electrode may be reused as a background structure to reflect light, so that an additional background structure is omitted.

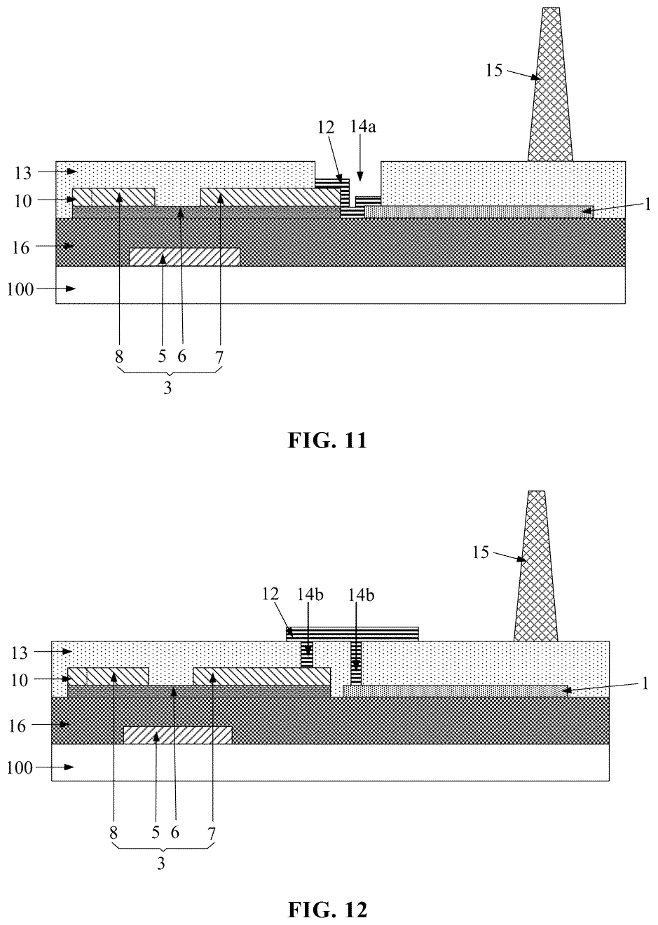

FIGS. 11 and 12 are yet another two schematic sectional views showing a partial region of a first substrate in a display region according to an embodiment of the present disclosure. As shown in FIGS. 11 and 12, unlike the case where the pixel electrode 1 is located between the gate insulating layer 16 and the first base substrate 100 as shown in FIGS. 5 and 8A to 10B, in the solution shown in FIGS. 11 and 12, the pixel electrode 1 is located between the gate insulating layer 16 and the passivation layer 13.

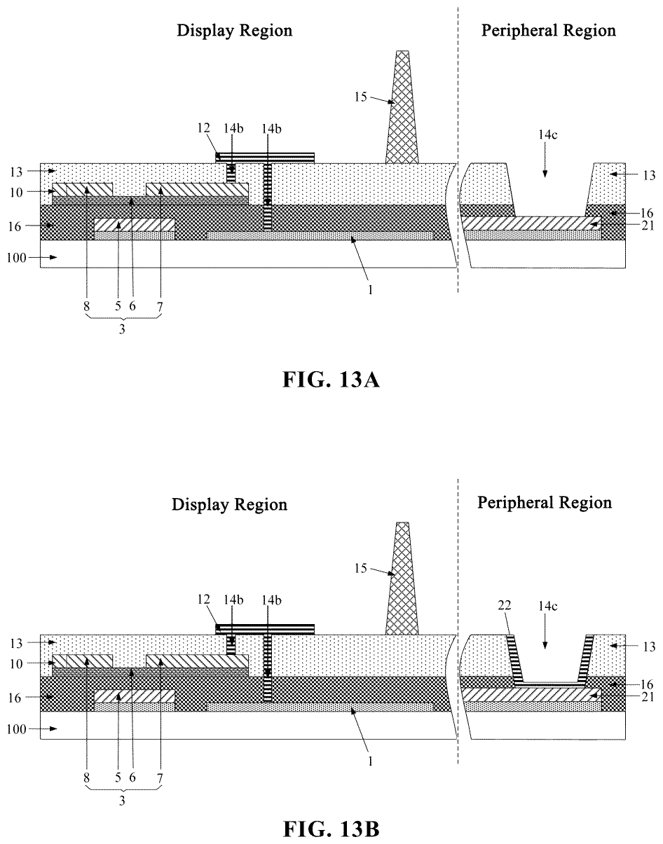

FIG. 13A is a schematic sectional view showing partial regions of a first substrate in a display region and a peripheral region according to an embodiment of the present disclosure. As shown in FIG. 13A, in some embodiments, the first substrate further includes a plurality of pads 21 in the peripheral region and disposed in the same layer as the gate 5 of the thin film transistor 3, and the passivation layer 13 is formed with a third via 14c communicated from a side surface of the passivation layer 13 distal from the first base substrate 100 to the pad 21. A metal finger on a flexible printed circuit (FPC) may be bonded to the pad 21 through the third via 14c.

It should be noted that when the pixel electrode 1 and the gate 5 are prepared through a half tone mask patterning process, since the pad 21 and the gate 5 are disposed in the same layer, there is also a portion disposed in the same layer as the pixel electrode below the pad 21.

It is found in practical applications that the metal finger on the FPC can only contact the pads 21 at the bottom of the third via 14c through a lower surface, with a relatively small contact area and low bonding reliability.

FIG. 13B is a schematic sectional view showing partial regions of a first substrate in a display region and a peripheral region according to an embodiment of the present disclosure. As shown in FIG. 13B, to effectively improve the above technical problem, in an embodiment of the present disclosure, a second conductive connection structure 22 is formed on a side wall of the third via 14c and on a surface of the pad 21 distal from the first base substrate 100, in which case the second conductive connection structure 22 can be tightly connected to the pad 21 below. While a bonding process is performed on the metal finger on the FPC and the first substrate, the metal finger may not only contact a part of the second conductive connection structure 22 at the bottom of the third via 14c, but also contact a part of the second conductive connection structure 22 on the side wall of the third via 14c, so that the contact area with the metal finger is increased, and the bonding reliability is effectively improved.

In some embodiments, when a first conductive connection structure 12 is provided on the first substrate 1000, the second conductive connection structure 22 and the first conductive connection structure 12 are disposed in the same layer. In this case, the first conductive connection structure 12 and the second conductive connection structure may be simultaneously prepared based on the same patterning process, which is beneficial to reducing steps of the preparation process.

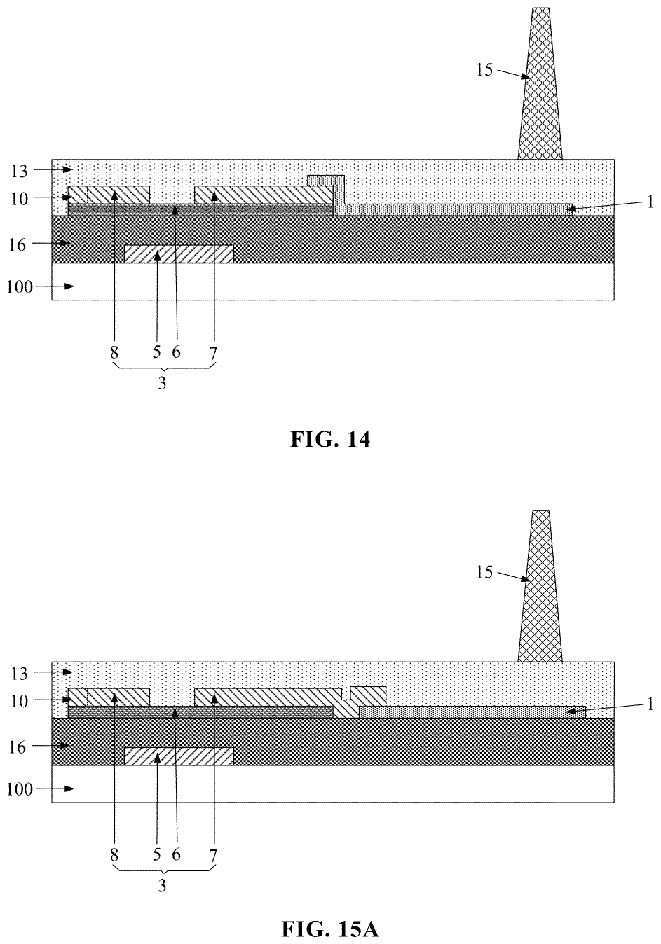

It should be noted that FIGS. 13A and 13B merely exemplarily depict a pixel unit in the display region as shown in FIG. 8A, which is merely for exemplary purposes. In an embodiment of the present disclosure, the pixel unit in the display region in FIGS. 13A and 13B may also adopt other forms, which is not limited in the present disclosure. FIG. 14 is another schematic sectional view showing a partial region of a first substrate in a display region according to an embodiment of the present disclosure. As shown in FIG. 14, unlike the previous embodiment in which the pixel electrode 1 is not in contact with the corresponding first electrode 7, but electrically connected to the corresponding first electrode 7 through the first conductive connection structure 12, in the solution shown in FIG. 14, the pixel electrode 1 is in direct contact with the corresponding first electrode 7.

In some embodiments, a portion of the pixel electrode 1 is lapped on a side surface of the corresponding first electrode 7 distal from the first base substrate 100.

With continued reference to FIGS. 5, and 8A to 14, in some embodiments, an orthographic projection of the active layer 6 on the first base substrate 100 covers orthographic projections of the first electrode 7 and the second electrode 8 on the first base substrate 100. With such a design, the active layer 6, the first electrode 7 and the second electrode 8 may be prepared through one mask process based on a half tone mask patterning process, which is beneficial to reducing the number of mask processes in the preparation flow of the first substrate and reducing the production cost. For the process of preparing the active layer 6, the first electrode 7 and the second electrode 8 through the half tone mask patterning process, reference may be made to the following.

In the solution shown in FIG. 14, the active layer 6, the first electrode 7, and the second electrode 8 are prepared through a half tone mask patterning process to reduce the number of mask processes, but it makes side surfaces of the first electrode 7 and the second electrode 8 facing the first base substrate 100 always in contact with the active layer 6, and thus, the pixel electrode 1 cannot be disposed in contact with the side surface of the first electrode 7 facing the first base substrate 100.

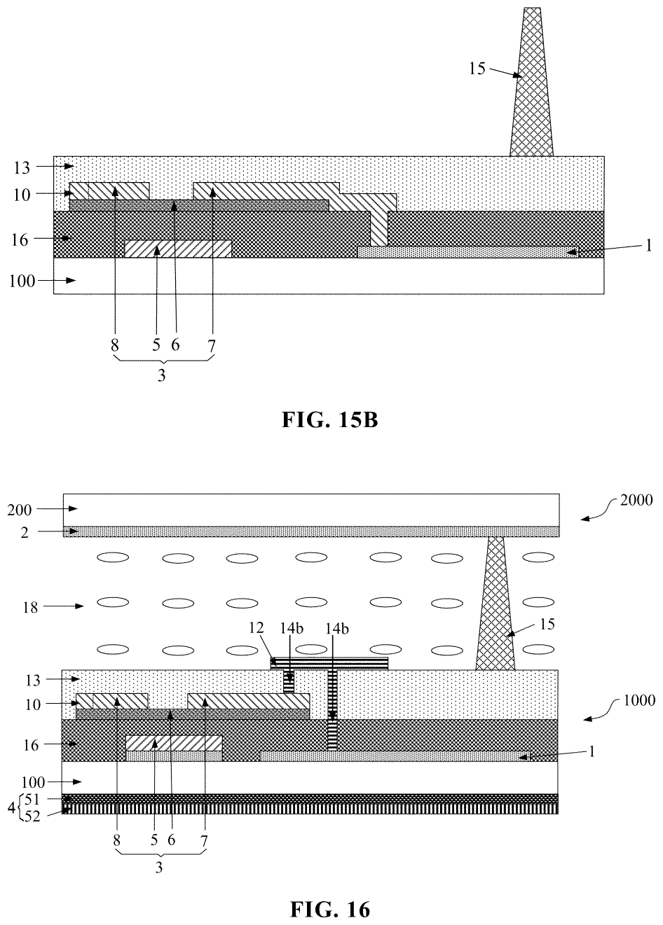

FIGS. 15A and 15B are further schematic sectional views showing a partial region of a first substrate in a display region according to an embodiment of the present disclosure. As shown in FIGS. 15A and 15B, without considering reducing the number of mask processes, the active layer 6 and the first electrode 7 may be prepared through different mask processes, and in this case, the pixel electrode 1 may be enabled to contact the side surface of the first electrode 7 facing the first base substrate 100. In other words, a portion of the first electrode 7 is lapped on a side surface of the pixel electrode 1 distal from the first base substrate 100 (FIG. 15A). Alternatively, the first electrode 7 is in contact with the side surface of the pixel electrode 1 distal from the first base substrate 100 through a via in the gate insulating layer 16 (FIG. 15B).

FIG. 16 is a schematic sectional view showing a partial region of a liquid crystal writing screen according to an embodiment of the present disclosure. As shown in FIG. 16, the liquid crystal writing screen includes a first substrate and a second substrate opposite to the first substrate, and a liquid crystal layer between the first substrate and the second substrate. The first substrate may be the first substrate in any of the above embodiments, and for specific description of the first substrate, reference may be made to the contents in the foregoing embodiments, details of which are not repeated here.

The second substrate includes a second base substrate 200 and a common electrode 2 on a side of the second base substrate 200 facing the first substrate.

In some embodiments, the second base substrate 200 is a flexible substrate. Therefore, when an external force is applied, the force can be transmitted to the bistable liquid crystal layer more easily, and the writing effect of the liquid crystal writing screen is improved. Specifically, the second base substrate board 200 is made of a material including PET, for example, is a PET film.

In some embodiments, a background structure 4 is disposed on a side of the first substrate 1000 distal from the second substrate 2000, or on a side of the second substrate distal from the first substrate.

Optionally, the background structure 4 includes a background film 51 (e.g., a black PET film) with a preset background color, so that the liquid crystal writing screen presents the preset background color in an initial state.

In some embodiments, when the background film 51 is a translucent film, a reflective film 52 (e.g., a silver film) is provided on a side of the background film 51 distal from the first substrate. The reflective film 52 may reflect the light transmitted through the background film 51, and part of the reflected light may be transmitted through the background film 51 again and then scattered by the pixel unit, so that the background brightness is further increased.

Based on a same inventive concept, an embodiment of the present disclosure further provides a method for preparing a liquid crystal writing screen, which may be applied to preparing the liquid crystal writing screen according to any one of the foregoing embodiments.

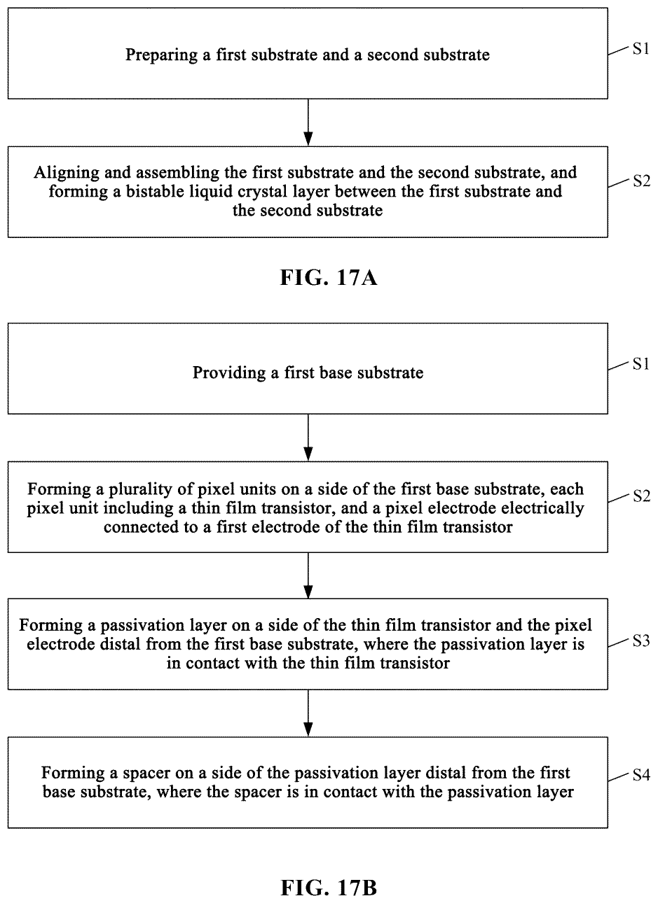

FIG. 17A is a flowchart of a method for preparing a liquid crystal writing screen according to an embodiment of the present disclosure, and FIG. 17B is a flowchart of a method for preparing a first substrate according to an embodiment of the present disclosure. As shown in FIGS. 17A and 17B, the method for preparing a liquid crystal writing screen includes the following steps Sa to Sb.

At step Sa, preparing a first substrate and a second substrate.

At step Sb, aligning and assembling the first substrate and the second substrate, and forming a bistable liquid crystal layer between the first substrate and the second substrate.

Referring to FIG. 17B, the step Sa includes the following steps S1 to S4.

At step S1, providing a first base substrate.

At step S2, forming a plurality of pixel units on a side of the first base substrate, each pixel unit including a thin film transistor, and a pixel electrode electrically connected to a first electrode of the thin film transistor.

At step S3, forming a passivation layer on a side of the thin film transistor and the pixel electrode distal from the first base substrate, where the passivation layer is in contact with the thin film transistor.

At step S4, forming a spacer on a side of the passivation layer distal from the first base substrate, where the spacer is in contact with the passivation layer.

The pixel electrode in the embodiments of the present disclosure is disposed between the first base substrate and the passivation layer, so that at least the passivation layer is present on a side of the pixel electrode distal from the first base substrate, which can effectively cover the pixel electrode to function as an insulation protective layer in the existing art. Through the above design, the first substrate provided in the embodiments of the present disclosure does not need an additional and separate insulation protective layer, so that compared with the first substrate in the existing art, the first substrate in the embodiments of the present disclosure has a simpler structure; and since the insulation protective layer is omitted, a process step for preparing the insulation protective layer is omitted during preparation of the first substrate, thereby simplifying the preparation process of the first substrate and thus the overall preparation process of the liquid crystal writing screen.

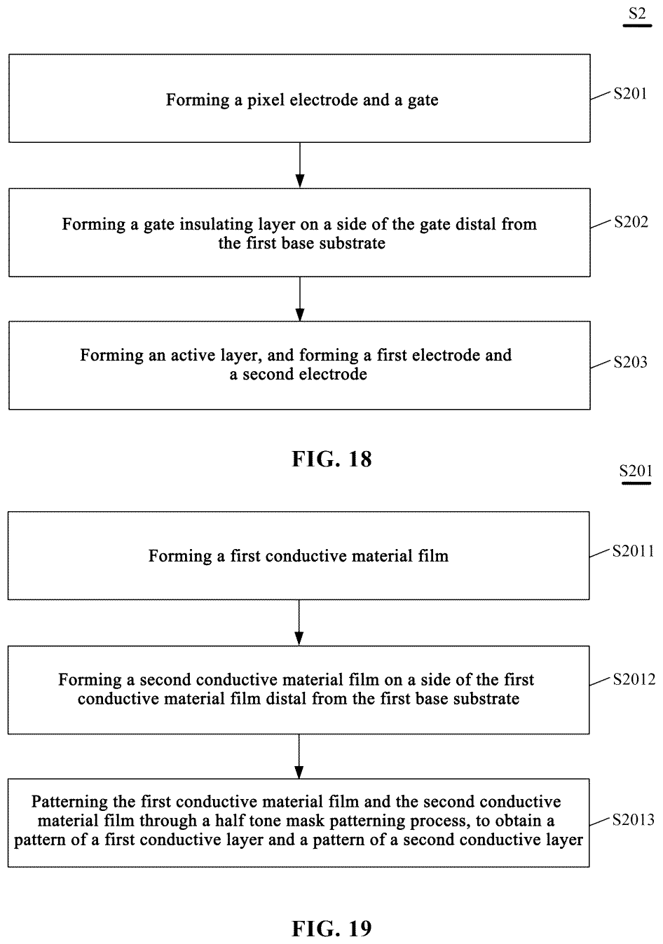

FIG. 18 is a flowchart of an optional implementation of step S2 according to an embodiment of the present disclosure. As shown in FIG. 18, in some embodiments, the step S2 includes the following steps S201 to S203.

At step S201, forming a pixel electrode and a gate.

At step S202, forming a gate insulating layer on a side of the gate distal from the first base substrate.

At step S203, forming an active layer, and forming a first electrode and a second electrode.

FIG. 19 is a flowchart of an optional implementation of step S201 according to an embodiment of the present disclosure. As shown in FIG. 19, in some embodiments, the step S201 includes the following steps S2011 to S2013.

At step S2011, forming a first conductive material film.

The first conductive material film may be formed on a side of the first base substrate through a deposition process. Optionally, the first conductive material includes a transparent conductive material, such as indium tin oxide.

At step S2012, forming a second conductive material film on a side of the first conductive material film distal from the first base substrate.

The second conductive material film may be formed on a side of the first conductive material film distal from the first base substrate through a deposition process. Optionally, the second conductive material includes a metal material or an alloy, such as aluminum or molybdenum.

At step S2013, patterning the first conductive material film and the second conductive material film through a half tone mask patterning process, to obtain a pattern of a first conductive layer and a pattern of a second conductive layer.

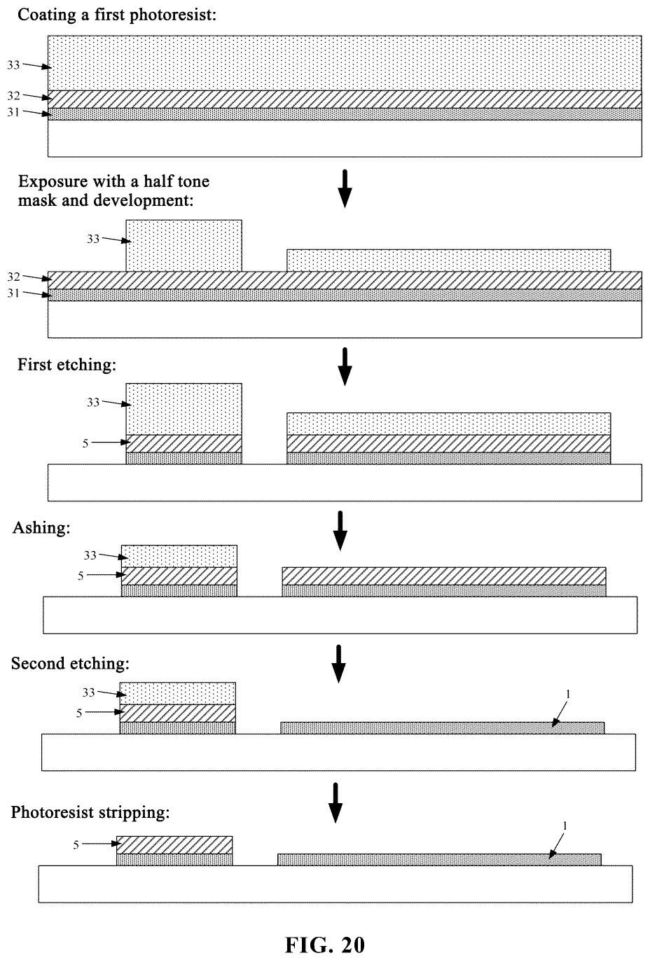

FIG. 20 is a schematic process flow for preparing a gate and a pixel electrode through a half tone mask patterning process according to an embodiment of the present disclosure. As shown in FIG. 20, firstly, a first photoresist 33 is coated on a side of the second conductive material film 32 distal from the first base substrate. Then, the first photoresist 33 is exposed with a half tone mask. Then, the first photoresist 33 is developed with a developing solution, where a portion of the first photoresist 33 in a region where a pattern of a second conductive layer is to be formed subsequently is completely reserved, a portion of the first photoresist 33 in a region where a pattern of a pixel electrode is to be formed subsequently is partially reserved (reduced in thickness), and the first photoresist 33 in other regions is completely removed. Then, the second conductive material film 32 and the first conductive material film 31 are respectively etched to obtain a pattern of a first conductive layer and a semi-finished pattern of a second conductive layer. Then, the first photoresist 33 is subjected to ashing so that the portion in the region where the pattern of the second conductive layer is to be formed subsequently is partially reserved (reduced in thickness), and the portion of the first photoresist 33 in the region where the pattern of the pixel electrode is to be formed subsequently is completely removed. Then, the semi-finished pattern of the second conductive layer is further etched to remove the second conductive material covering a surface of the pixel electrode and obtain a final pattern of the second conductive layer. Finally, the remaining first photoresist 33 is stripped.

The pattern of the first conductive layer includes a pixel electrode 1 and a first conductive structure (e.g., a portion directly below the gate line, and a portion directly below the gate) disposed in the same layer as the pixel electrode 1. The pattern of the second conductive layer includes a gate 5 and a second conductive structure (e.g., a gate line, and a pad) disposed in the same layer as the gate 5. An orthographic projection of the first conductive layer on the first base substrate covers an orthographic projection of the second conductive layer on the first base substrate.

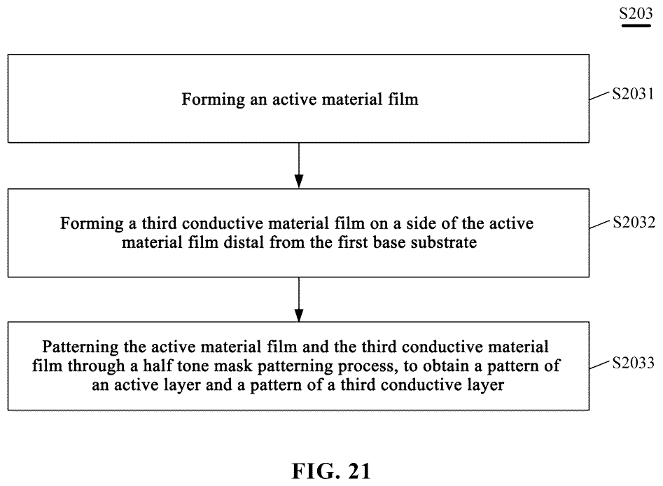

FIG. 21 is a flowchart of an optional implementation of step S203 according to an embodiment of the present disclosure. As shown in FIG. 21, in some embodiments, the step S203 includes the following steps S2031 to S2033.

At step S2031, forming an active material film.

The active material film may be formed on a side of the gate insulating layer distal from the base substrate through a deposition process. Optionally, the active material includes a semiconductor material such as amorphous silicon, polysilicon, or a metal oxide.

At step S2032, forming a third conductive material film on a side of the active material film distal from the first base substrate.

The third conductive material film may be formed on a side of the active material film distal from the first base substrate through a deposition process. Optionally, the third conductive material includes a metal material or an alloy, such as aluminum or molybdenum.

At step S2033, patterning the active material film and the third conductive material film through a half tone mask patterning process, to obtain a pattern of an active layer and a pattern of a third conductive layer.

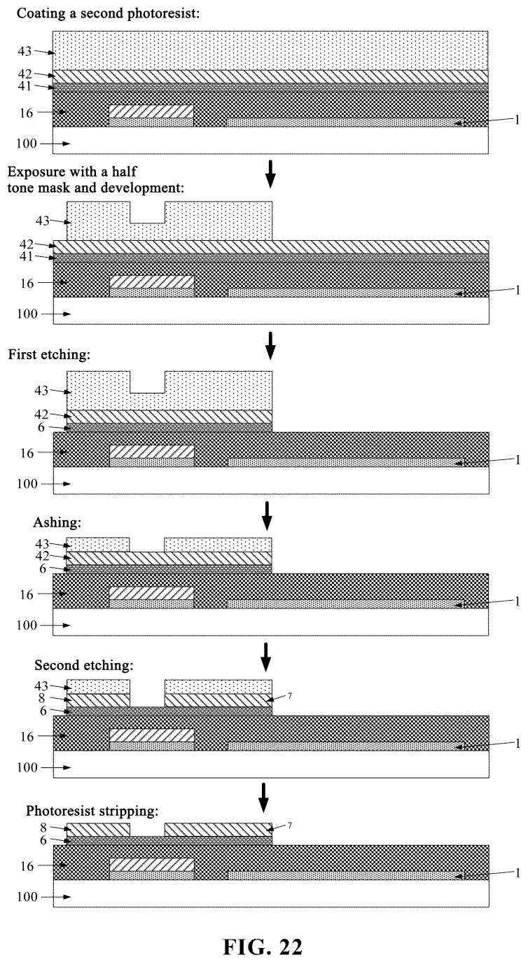

FIG. 22 is a schematic process flow for preparing an active layer, a first electrode, and a second electrode through a half tone mask patterning process according to an embodiment of the present disclosure. As shown in FIG. 22, first, a second photoresist 43 is coated on a side of the third conductive material film 42 distal from the first base substrate. Then, the second photoresist 43 is exposed with a half tone mask. Then, the second photoresist 43 is developed with a developing solution, where a portion of the second photoresist 43 in a region where a pattern of a third conductive layer is to be formed subsequently is completely reserved, a portion of the second photoresist 43 in a region where a channel region of an active layer is to be formed subsequently is partially reserved (reduced in thickness), and the second photoresist 43 in other regions is completely removed. Then, the third conductive material film 42 and the active material film 41 are respectively etched to obtain a pattern of an active layer 6 and a semi-finished pattern of a third conductive layer. Then, the second photoresist 43 is subjected to ashing so that the portion in the region where a pattern of the third conductive layer is to be formed subsequently is partially reserved (reduced in thickness), and the portion of the second photoresist 43 in the channel region of the active layer is completely removed. Then, the semi-finished pattern of the third conductive layer is further etched to remove the second conductive material covering a surface of the pixel electrode and obtain a final pattern of the second conductive layer. Finally, the remaining second photoresist 43 is stripped.

The third conductive layer includes a first electrode 7 and a second electrode 8, and a third conductive structure (e.g., a data line) disposed in the same layer as the first electrode 7 and the second electrode 8, and an orthographic projection of the active layer 6 on the first base substrate 100 covers orthographic projections of the first electrode 7 and the second electrode 8 on the first base substrate 100.

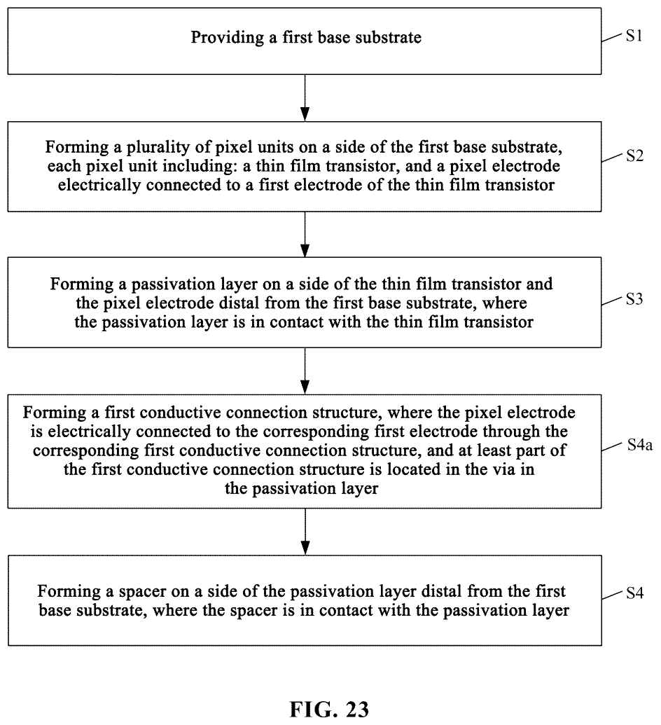

FIG. 23 is a flowchart of a method for preparing a first substrate according to an embodiment of the present disclosure. As shown in FIG. 23, when the first substrate includes the first conductive connection structure, a via (e.g., the first via or the second via described in the previous embodiments) communicated to the first electrode and/or the second electrode may be formed in the step S3, and a step S4a is further included between the step S3 and the step S4. The following describes only the step S4a in detail.

At step S4a, forming a first conductive connection structure, where the pixel electrode is electrically connected to the corresponding first electrode through the corresponding first conductive connection structure, and at least part of the first conductive connection structure is located in the via in the passivation layer.

Apparently, when the first substrate is provided with the second conductive connection structure in the peripheral region, the second conductive connection structure is formed synchronously in the step S4a.

It will be appreciated that the above implementations are merely exemplary implementations for the purpose of illustrating the principle of the present disclosure, and the present disclosure is not limited thereto. It will be apparent to those skilled in the art that various modifications and variations may be made without departing from the spirit or essence of the present disclosure. Such modifications and variations should also be considered as falling into the protection scope of the present disclosure.

1. A liquid crystal writing screen, comprising a first substrate, a second substrate, and a bistable liquid crystal layer between the first substrate and the second substrate, wherein the first substrate comprises:
a first base substrate;
a plurality of pixel units on a side of the first base substrate proximate to the second substrate, wherein each of the plurality of pixel units comprises a thin film transistor, and a pixel electrode electrically connected to a first electrode of the thin film transistor;
a passivation layer on a side of the thin film transistor distal from the first base substrate and in contact with the thin film transistor, wherein the pixel electrode is between the first base substrate and the passivation layer; and
a spacer on a side of the passivation layer distal from the first base substrate and in contact with the passivation layer.

2. The liquid crystal writing screen according to claim 1, wherein the thin film transistor comprises a gate, an active layer, the first electrode, and a second electrode, wherein the first electrode and the second electrode are on a side of the active layer distal from the first base substrate; and
the passivation layer is in contact with the first electrode and/or the second electrode.

3. The liquid crystal writing screen according to claim 2, wherein the gate is on a side of the active layer proximate to the first base substrate, and a gate insulating layer is between the gate and the active layer; and
the pixel electrode is between the gate insulating layer and the passivation layer, or between the gate insulating layer and the first base substrate.

4. The liquid crystal writing screen according to claim 3, wherein the pixel electrode is on a side of the gate proximate to the first base substrate.

5. The liquid crystal writing screen according to claim 4, wherein the first substrate comprises a first conductive layer, and a second conductive layer on a side of the first conductive layer distal from the first base substrate;
the first conductive layer comprises the pixel electrode and a first conductive structure in the same layer as the pixel electrode;
the second conductive layer comprises the gate and a second conductive structure in the same layer as the gate; and
an orthographic projection of the first conductive layer on the first base substrate covers an orthographic projection of the second conductive layer on the first base substrate.

6. The liquid crystal writing screen according to claim 2, wherein the pixel electrode is in the same layer as the gate.

7. The liquid crystal writing screen according to claim 2, wherein the pixel electrode is electrically connected to the corresponding first electrode through a first conductive connection structure;
the passivation layer comprises a via into which at least part of the first conductive connection structure is received; and
an orthographic projection of the first conductive connection structure on the base first base substrate has an area less than an area of an orthographic projection of the pixel electrode connected to the first conductive connection structure on the first base substrate.

8. The liquid crystal writing screen according to claim 7, wherein the passivation layer is formed with a first via communicated from a side surface of the passivation layer distal from the first base substrate to the first electrode and the pixel electrode corresponding to the first electrode; and
at least part of the first conductive connection structure is in the first via, and the first conductive connection structure is in contact with both of the first electrode and the pixel electrode corresponding to the first electrode.

9. The liquid crystal writing screen according to claim 8, wherein the orthographic projection of the first conductive connection structure on the first base substrate is overlapped with an orthographic projection of the first via on the first base substrate.

10. The liquid crystal writing screen according to claim 7, wherein the passivation layer is formed with a second via set comprising at least two second vias, wherein at least one second via in the second via set is communicated from a side surface of the passivation layer distal from the first base substrate to the first electrode, and at least one second via in the second via set is communicated from the side surface of the passivation layer distal from the first base substrate to the pixel electrode corresponding to the first electrode;
the first conductive connection structure is in one-to-one correspondence with the second via set, and comprises at least two first conductive connection sub-structures and a second conductive connection sub-structure;
the first conductive connection sub-structures are in one-to-one correspondence with the second vias in the corresponding second via set, and each of the first conductive connection sub-structures is in a corresponding one of the second vias, and in contact with the first electrode or the pixel electrode; and
the second conductive connection sub-structure is on a side of the passivation layer distal from the first base substrate, and connected to the first conductive connection sub-structures to electrically connect the first electrode to the pixel electrode.

11. The liquid crystal writing screen according to claim 10, wherein for any second via in the second via set, the second via has a first orthographic projection on the first base substrate, and the first conductive connection structure corresponding to the second via has a second orthographic projection on the first base substrate; and
the first orthographic projection is in a coverage area of the second orthographic projection, and a distance from any point on an edge of the first orthographic projection to any point on an edge of the second orthographic projection is greater than or equal to 1 μm, and/or
for any second via in the second via set that is communicated from the side surface of the passivation layer distal from the first base substrate to the first electrode, the second via has a third orthographic projection on the first base substrate, and the first electrode corresponding to the second via has a fourth orthographic projection on the first base substrate, and
the third orthographic projection in in a coverage area of the fourth orthographic projection, and a distance from any point on an edge of the third orthographic projection to any point on an edge of the fourth orthographic projection is greater than or equal to 1 μm, and/or
for any second via in the second via set that is communicated from the side surface of the passivation layer distal from the first base substrate to the pixel electrode, the second via has a fifth orthographic projection on the first base substrate, and the pixel electrode corresponding to the second via has a sixth orographic projection on the first base substrate; and
the fifth orthographic projection is in a coverage area of the sixth orthographic projection, and a distance from any point on an edge of the fifth orthographic projection to any point on an edge of the sixth orthographic projection is greater than or equal to 1 μm.

12-13. (canceled)

14. The liquid crystal writing screen according to claim 7, wherein the first conductive connection structure is made of a material comprising a transparent conductive material comprising a metal oxide;
a total contact surface area between the first conductive connection structure and the first electrode connected to the first conductive connection structure is in a range of 100 μm² to 400 μm²; and
a total contact surface area between the first conductive connection structure and the pixel electrode connected to the first conductive connection structure is in a range of 100 μm² to 400 μm², or
the first conductive connection structure is made of a material comprising a metal material;
a total contact surface area between the first conductive connection structure and the first electrode connected to the first conductive connection structure is in a range of 0.25 μm² to 2.25 μm²; and
a total contact surface area between the first conductive connection structure and the pixel electrode connected to the first conductive connection structure is in a range of 0.25 μm² to 2.25 μm.

15. (canceled)

16. The liquid crystal writing screen according to claim 7, further comprising:
a plurality of pads in a peripheral region of the liquid crystal writing screen and in the same layer as the gate of the thin film transistor;
the passivation layer is formed with a third via communicated to the pad, and a second conductive connection structure is formed on a side wall of the third via and on a surface of the pad distal from the first base substrate; and
the second conductive connection structure is in the same layer as the first conductive connection structure.

17. The liquid crystal writing screen according to claim 2, wherein a portion of the pixel electrode is lapped on a side surface of the corresponding first electrode distal from the first base substrate.

18. The liquid crystal writing screen according to claim 2, wherein an orthographic projection of the active layer on the first base substrate covers orthographic projections of the first electrode and the second electrode on the first base substrate.

19. The liquid crystal writing screen according to claim 1, wherein the spacer has a density of 100/mm² to 500/mm².

20. The liquid crystal writing screen according to claim 1, wherein the second substrate comprises a second base substrate and a common electrode on a side of the second base substrate facing the first substrate; and
the second base substrate is a flexible substrate.

21. A method for preparing the liquid crystal writing screen according to claim 1, comprising:
preparing a first substrate and a second substrate;
aligning and assembling the first substrate and the second substrate, and forming a bistable liquid crystal layer between the first substrate and the second substrate;
wherein preparing the second substrate comprises:
providing a first base substrate;
forming a plurality of pixel units on a side of the first base substrate, wherein each of the plurality of pixel units comprises a thin film transistor, and a pixel electrode electrically connected to a first electrode of the thin film transistor;
forming a passivation layer on a side of the thin film transistor and the pixel electrode distal from the first base substrate, wherein the passivation layer is in contact with the thin film transistor; and
forming a spacer on a side of the passivation layer distal from the first base substrate, wherein the spacer is in contact with the passivation layer.

22. The method according to claim 21, wherein forming the plurality of pixel units on the side of the first base substrate comprises: forming the pixel electrode and forming a gate; and
forming the pixel electrode and forming the gate comprises:
forming a first conductive material film;
forming a second conductive material film on a side of the first conductive material film distal from the first base substrate; and
patterning the first conductive material film and the second conductive material film through a half tone mask patterning process, to obtain a pattern of a first conductive layer and a pattern of a second conductive layer, wherein the first conductive layer comprises the pixel electrode and a first conductive structure in the same layer as the pixel electrode, the second conductive layer comprises the gate and a second conductive structure in the same layer as the gate, and an orthographic projection of the first conductive layer on the first base substrate covers an orthographic projection of the second conductive layer on the first base substrate, and/or
forming the plurality of pixel units on the side of the first base substrate comprises: forming an active layer, and forming the first electrode and a second electrode;
forming the active layer and forming the first electrode and the second electrode comprises;
forming an active material film,
forming a third conductive material film on a side of the active material film distal form the first base substrate; and
patterning the active material film and the third conductive material film through a half tome mast patterning process to obtain a pattern of the active layer and a pattern of a third conductive layer, wherein the third conductive layer comprises the first electrode, the second electrode, and a third conductive structure in the same later as the first electrode and the second electrode, and an orthographic projection of the active layer on the first base substrate covers orthographic projections of the first electrode and the second electrode on the first base substrate.

23. (canceled)

24. The method according to claim 21, wherein the pixel electrode is electrically connected to the corresponding first electrode through a first conductive connection structure, and the passivation layer comprises a via; and
after forming the passivation layer and before forming the spacer, the method further comprises:
forming a first conductive connection structure, wherein the pixel electrode is electrically connected to the corresponding first electrode through the corresponding first conductive connection structure, and at least part of the first conductive connection structure is in the via of the passivation layer.
